(19) United States
(12) Patent Application Publication
(10) Pub. No.: US 2008/0179895 A1
(43) Pub. Date: Jul. 31, 2008

(54) Two-way fastening structure for tablet PC

(75) Inventor: Yun-Tang Lin, Taipei City (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Inventec Corporation, Taipei City (TW)

(21) Appl. No.: 11/699,901

(22) Filed: Jan. 30, 2007

(51) Int. Cl. E05C 19/16; E05C 19/10

(52) U.S. Cl. 292/116; 292/251.5

(57) ABSTRACT

A two-way fastening structure for a tablet PC comprises a mainframe, a cover body, a pusher, and a fastener. The mainframe has a fastening groove, and a magnetic element is provided adjacent to the fastening groove. The cover body has a bottom wall and a top wall opposite to the bottom wall. The bottom wall and the top wall respectively have a first opening and a second opening corresponding to the fastening groove. The pusher is slidably disposed within the cover body corresponding to the first opening and the second opening. The pusher is provided with an elastic element at one end, such that the pusher has a first position and a second position. When the cover body is turned to cover the mainframe, the magnetic element attracts the fastener, such that the fastener protrudes from the first opening or the second opening, and thereby snapping in the fastening groove.

### BACKGROUND OF THE INVENTION

1. Field of Invention

The present invention relates to a two-way fastening structure, and more particularly, to a two-way fastening structure for a tablet PC, whose cover body can rotate to cover it.

2. Related Art

The configuration of a conventional notebook PC is substantially divided into two main parts: a body base and a cover body screen connected with the body base by a revolving shaft mechanism. When the notebook is used, the cover body of screen is opened from the body base. When the cover body is closed, the body base of the notebook PC is designed with a hook for fastening the cover body with the body base. With the hook structure, the screen cover body can be closed when the notebook is accommodated or carried along, otherwise, the screen cover body opens, which results in scratching the screen surface, dust entering into the gaps of the keyboards, or damage to the revolving shaft mechanism.

However, there is a computer similar to a notebook, and its liquid crystal screen can be switched to a tablet mode from a notebook mode, i.e., the liquid crystal screen turns backwards to allow the panel to face outwards. Then, the liquid crystal screen is drawn close to the keyboard and is closely combined with the keyboard, thus, a liquid crystal display is formed, i.e., a tablet PC. A snapping member is usually provided at a position where the liquid crystal screen covers the body base, which prevents the liquid crystal screen from being opened optionally, and when the liquid crystal screen is rotated and folded into a briefing mode for writing and viewing, the snapping member can be used for securing and positioning.

U.S. Pat. No. 6,870,740 provides a two-way fastening device, wherein two surfaces of the cover body are both covered and fasten to the base. An external force is applied to the actuating element to make it have four state selections of moving positions, so as to drive the fastener to protrude from the base and fastened thereto, or to release the fastener and disengage it from the base, thus, the recovering element drives the fastener and the actuating element back to the original state.

U.S. Patent Publication No. 20050180562 provides a hidden hook interlocking structure. The connecting bar is pushed upon operating a key, and the connecting bar is pivoted to the hook that is magnetic conductive, such that the hook is fastened due to being attracted by the magnetic member of the body.

### SUMMARY OF THE INVENTION

In view of the prior art disclosed above, the required elements are relatively large in number, resulting in a heavy burden on the cost. The structure is complex, such that it is difficult to be assembled. The process required for fastening is not simple enough. Therefore, the present invention discloses a two-way fastening structure for a tablet PC.

The two-way fastening structure for a tablet PC disclosed in the present invention comprises a mainframe, a cover body, a pusher, and a fastener. The mainframe at least has a fastening groove, and a magnetic element is provided adjacent to the fastening groove. The cover body has a bottom wall and a top wall opposite to the bottom wall, and the bottom wall and the top wall respectively have a first opening and a second opening corresponding to the fastening groove. One side of the cover body opposite to the first opening and the second opening is pivoted to one side of the mainframe in a two-way rotational manner, such that the cover body is drawn close to the mainframe with the bottom wall or the top wall selectively. The pusher is slidably disposed within the cover body corresponding to the first opening and the second opening and is provided with an elastic element at one end, such that it has a first position under normal state and a second position when moved under stress. The pusher is provided with guide rails corresponding to the first opening and the second opening respectively. Moreover, the fastener is magnetic conductive, and is movably disposed within the guide rail. When the cover body is drawn close to the mainframe with the bottom wall or the top wall, the fastener protrudes from the first opening or the second opening due to being attracted by the magnetic element, so as to be snapped in the fastening groove.

The two-way fastening structure for a tablet PC disclosed in the present invention reduces the number of elements required in the conventional art, so as to simplify the structure and the operation process. In addition, the operation process of the present invention is simple and convenient, and the fastening and disengaging are easily achieved, which caters to humanization of the design, and the fabrication process is easy, thus reducing the manufacturing cost.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1A is a schematic view of the application of a tablet PC according to the present invention.

FIG. 1B is a partially enlarged view of the key body for the tablet PC of the present invention.

FIG. 2A is a schematic view of the continuous actions of the fastener of the present invention before it is snapped.

FIG. 2B is a schematic view of the continuous actions of a fastener of the present invention when it has already entered into the fastening groove.

FIG. 2C is a schematic view of the continuous actions of the fastener of the present invention when it is snapped within the fastening groove.

FIG. 3A is a schematic view of a fastener of the present invention when it moves along a guide rail in two directions.

FIG. 3B is a schematic view of the position for the magnetic element of the present invention.

FIG. 3C is a schematic view of another position for the magnetic element of the present invention.

FIG. 3D is a schematic view of the position for the fastening groove with magnetic attraction provided by the present invention.

### DETAILED DESCRIPTION OF THE INVENTION

As for a two-way fastening structure for a tablet PC disclosed in the present inventions, the design of the two-way fastening structure is not limited to be applied to the tablet PC, and the techniques disclosed in the present invention also can be applied to, for example, objects capable of being correspondingly opened and covered. In the following detailed description of the present invention, the tablet PC is taken as an application embodiment of the present invention.

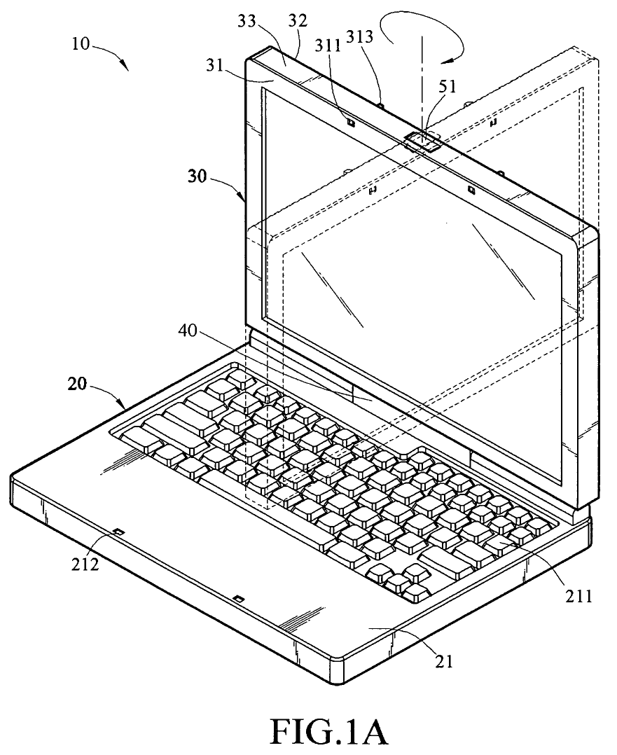

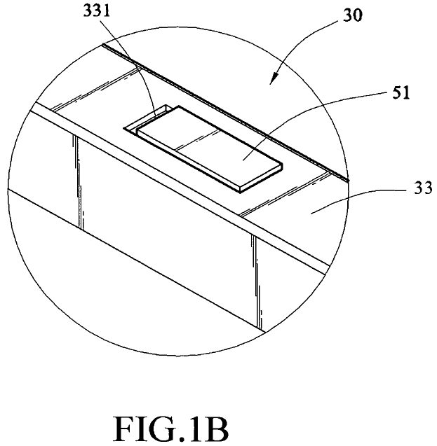

Please refer to FIGS. 1A and 1B. FIG. 1A is a schematic view of the application of a tablet PC 10 according to the present invention. FIG. 1B is a partially enlarged view of the key body for the tablet PC 10 of the present invention. As shown in FIGS. 1A and 1B, the tablet PC 10 comprises a mainframe 20 and a cover body 30. The cover body 30 is pivoted to the mainframe 20, so as to revolve relative to the mainframe 20 and cover thereon.

The surface of the mainframe 20 has a panel 21 with a plurality of keys 211 accommodated therein. The panel 21 further has at least one fastening groove 212 formed thereon. The cover body 30 has a bottom wall 31, a top wall 32 opposite to the bottom wall 31, and a side wall 33 between the bottom wall 31 and the top wall 32. The side wall 33 is opened with a sliding groove 331. The cover body 30 has a first opening 311 and a second opening 321 at the bottom wall 31 and the top wall 32 corresponding to the fastening groove 212. One side of the cover body 30 opposite to the first opening 311 and the second opening 321 is pivoted to one side of the mainframe 20 in a two-way rotational manner. Therefore, the cover body 30 is turned to be covered and opened relative to the mainframe 20 with the pivoting element 40 as the revolving shaft. When the cover body 30 has not turned but intended to cover the mainframe 20, it approaches and substantially touches the panel 21 of the mainframe 20 with the bottom wall 31. When the cover body 30 has already turned and intended to cover the mainframe 20, it approaches and substantially touches the panel 21 with the top wall 32, i.e., the cover body 30 approaches the mainframe 20 with the bottom wall 31 or the top wall 32 selectively.

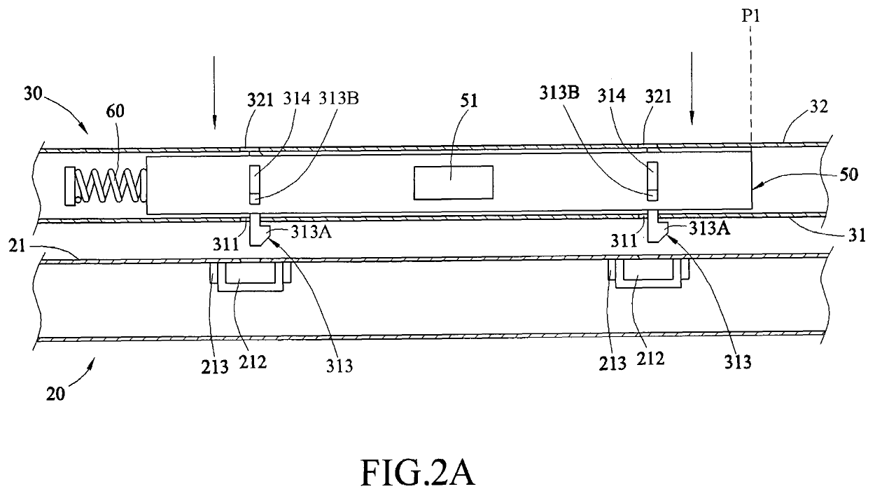

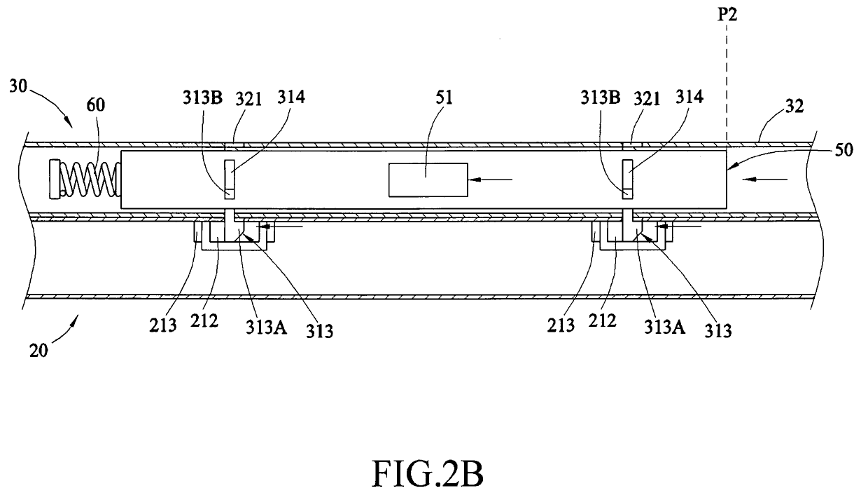

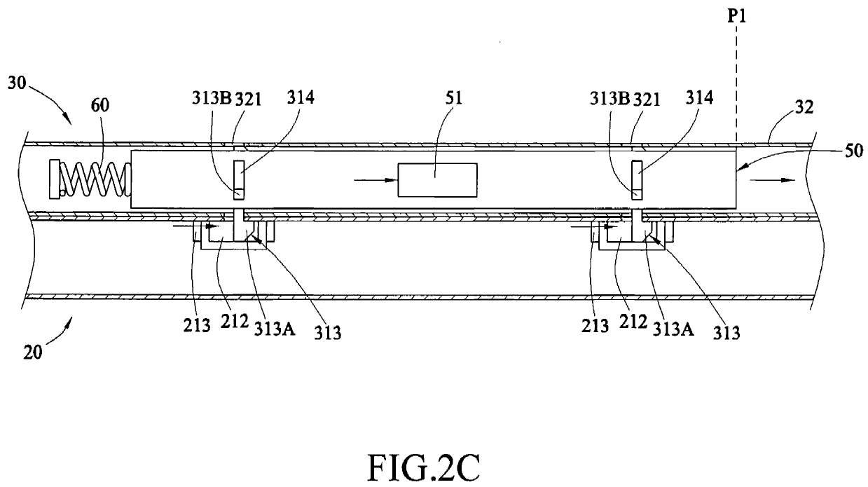

Please refer to FIGS. 2A, 2B and 2C. FIG. 2A is a schematic view of the continuous actions of the fastener of the present invention before it is snapped. FIG. 2B is a schematic view of the continuous actions of a fastener of the present invention when it has already entered into the fastening groove. FIG. 2C is a schematic view of the continuous actions of the fastener of the present invention when it is snapped within the fastening groove. As shown in FIGS. 2A, 2B and 2C, a magnetic element 213 is provided adjacent to both sides of the fastening groove 212. The magnetic element 213 can be a magnet, and the pusher 50 has a key body 51 protruding from the sliding groove 331. The pusher 50 is slidably arranged within the cover body 30 corresponding to the first opening 311 and the second opening 321. The pusher 50 is provided with an elastic element 60, such that it has a first position P1 under normal state and a second position P2 when being moved under stress. The pusher 50 is provided with guide rails 314 corresponding to the first opening 311 and the second opening 321 respectively. Moreover, the fastener 313 is made of magnetic material. Hook portions 313A are formed at both opposite ends of the fastener 313. The fastener 313 has a protruding portion 313B. The protruding portion 313B is embedded in the guide rails 314, such that the fastener 313 moves along the guide rails 314.

When the cover body 30 is intended to cover the mainframe 20 with the bottom wall 31, the pusher is located at the first position P1. The cover body 30 is pivotally turned, such that the bottom wall 31 approaches the mainframe 20. When the first opening 311 gets close to the magnetic attraction scope of the magnetic element 213 for the fastening groove 212, one end of the fastener 313 moves along the guide rails 314 and protrudes from the opening 311 due to being magnetic attracted by the magnetic element 213 in the fastening groove 212. After the bottom wall 31 substantially touches the panel 21, in order to fasten one end of the magnetic fastener 313 into the fastening groove 212, an external force is applied to the key body 51 to make it move along the sliding groove 331 towards the elastic element 60, thus, the pusher 50 applies a pressure to the elastic element 60, and then moves to the second position P2. Meanwhile, the elastic element 60 accumulates a restoring force due to the pressure.

When the hook portion 313A of the fastener 313 enters into the fastening groove 212 and the key body 51 is released from the external force, the restoring force accumulated by the elastic element 60 pushes the pusher 50 and thereby makes the fastener 313 move along the direction of the restoring forces of the elastic element 60. At this time, the pusher 50 moves back to the first position P1, and the hook portion 313A of the fastener 313 is completely snapped into the fastening groove 212.

When the fastener 313 is intended to be released from the snapping state, the pusher 50 is still located at the second position P2. When an external force is applied to the key body 51 in the direction towards the elastic element 60, and the cover body 30 is gradually opened, the key body 51 moves along the sliding groove 331, and thereby the pusher 50 applies a pressure to the elastic element 60. The elastic element 60 accumulates a restoring force due to the pressure, and the hook portion 313A in the fastener 313 is also disengaged from the snapping state. When the key body 51 is released from the external force, the restoring force accumulated by the elastic element 60 pushes the pusher 50 once again, so that the fastener 313 is driven to move along the direction of the restoring forces of the elastic element 60. However, the hook portion 313A of the fastener 313 at this time has been completely released from the fastening groove 212, and the pusher 50 returns to the first position P1.

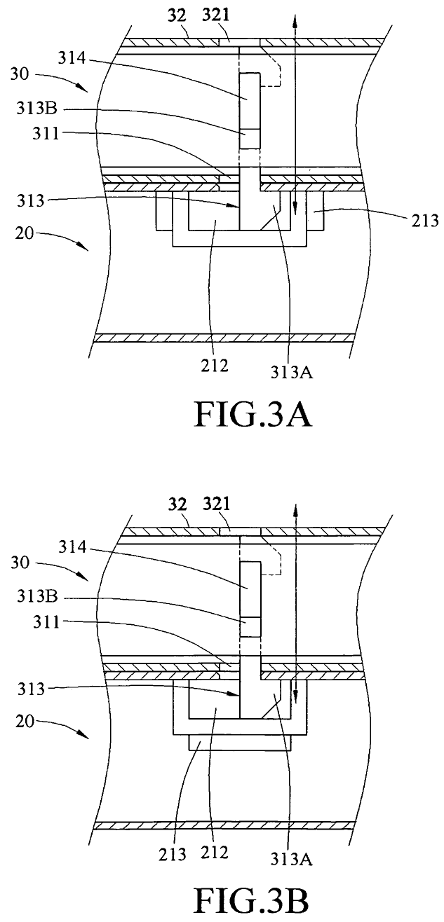

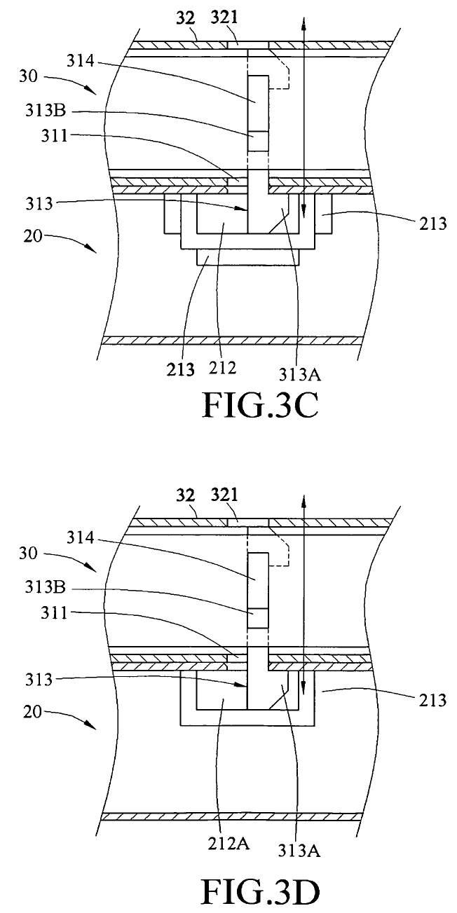

Please refer to FIGS. 3A, 3B, 3C and 3D. FIG. 3A is a schematic view of a fastener of the present invention when it moves along a guide rail in two directions. FIG. 3B is a schematic view of the position for the magnetic element of the present invention. FIG. 3C is a schematic view of another position for the magnetic element of the present invention. FIG. 3D is a schematic view of the position for the fastening groove with magnetic attraction provided by the present invention. As shown in FIG. 3A, when the cover body 30 is intended to cover the mainframe 20 with the top wall 32, the cover body 30 is pivotally turned, such that the bottom wall 31 approaches the mainframe 20. When the second opening 321 gets close to the magnetic attraction scope of the magnetic element 213 for the fastening groove 212, one end of the fastener 313 moves along the guide rails 314 and protrudes from the opening 321 due to being magnetic attracted by the magnetic element 213 in the fastening groove 212. After the top wall 32 substantially touches the panel 21, in order to fasten one end of the magnetic fastener 313 to the fastening groove 212, an external force is applied to the key body 51 in the direction towards the elastic element 60 to make it move along the sliding groove 331, such that the pusher 50 applies

a pressure to the elastic element 60. The elastic element 60 accumulates a restoring force due to the pressure.

When the hook portion 313A of the fastener 313 enters into the fastening groove 212 and the key body 51 is released from the external force, the restoring force accumulated by the elastic element 60 pushes the pusher 50, and the fastener 313 is driven to move towards the direction of the restoring forces of the elastic element 60. Thus, the hook portion 313A of the fastener 313 is completely snapped into the fastening groove 212. When the fastener 313 is intended to be released from the snapping state, it can be achieved by repeating the above steps.

As shown in FIGS. 3B and 3C, the magnetic element 213 can be located at the bottom of the fastening groove 212, or at both opposite sides and the bottom of the fastening groove 212. As for the position for disposing the magnetic element 213, the magnetic attraction effect that can be achieved is considered as the key point.

As shown in FIG. 3D, when the magnetic conductive fastener 313 gets close to the magnetic attraction scope of the fastening groove 212A, the fastener 313 enters into the fastening groove 212A to be ready to be snapped.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A two-way fastening structure for a tablet PC, comprising:
a mainframe, having a fastening groove and a magnetic element adjacent to the fastening groove;
a cover body, having a bottom wall and a top wall opposite to the bottom wall, wherein the bottom wall and the top wall respectively have a first opening and a second opening communicating with the first opening, both of the first opening and the second opening are corresponding to the fastening groove, and one side of the cover body opposite to the first opening and the second opening is pivoted to one side of the mainframe in a two-way rotational manner, such that the cover body is drawn close to the mainframe with the bottom wall or the top wall selectively;
a pusher, slidably disposed within the cover body corresponding to the first opening and the second opening, wherein the pusher is provided with guide rails and an elastic element the guide rails are disposed between the first opening and the second opening, the elastic element is disposed at one end of the pusher, such that the pusher has a first position when the elastic element is under a normal state and a second position when the elastic element is pressed by the pusher; and
a fastener, made of magnetic material, the fastener including two hook portions disposed at two opposite ends of the fastener respectively, the fastener linearly slidably disposed within the guide rails, so as to protrude one of the hook portions from one of the first opening and the second opening,
wherein when the cover body is drawn close to the mainframe and the pusher is at the second position, one of the hook portions are attracted to enter the fastening groove by the magnetic element, so that the one of the hook portions are engaged with the fastening groove when the pusher is moved to the first position by the elastic element.

2. The two-way fastening structure for a tablet PC as claimed in claim 1, wherein the cover body has a sliding groove, and the pusher has a key body protruding from the sliding groove.

3. (canceled)

4. The two-way fastening structure for a tablet PC as claimed in claim 1, wherein the fastener is formed with a protruding portion embedded in the guide rail, such that the fastener moves along the guide rail.

5. The two-way fastening structure for a tablet PC as claimed in claim 1, wherein when the fastener is snapped in the fastening groove or released from the fastening groove, the pusher is located at the first position, and when the fastener enters into the fastening groove to be snapped or released, the pusher is located at the second position.

6. A two-way fastening structure for a tablet PC, comprising:
a mainframe, forming a fastening groove with magnetic attraction;
a cover body, with a bottom wall and a top wall corresponding to the bottom wall, wherein the bottom wall and the top wall respectively have a first opening and a second opening communicating with the first opening, both of the first opening and the second opening are corresponding to the fastening groove, and one side of the cover body opposite to the first opening and the second opening is pivoted to one side of the mainframe in a two-way rotational manner, such that the cover body is drawn close to the mainframe with the bottom wall or the top wall selectively;
a pusher, slidably arranged within the cover body corresponding to the first opening and the second opening, wherein the pusher is provided with guide rails and an elastic element the guide rails are disposed between the first opening and the second opening, the elastic element is disposed at one end of the pusher, such that the pusher has a first position when the elastic element is under a normal state and a second position when the elastic element is pressed by the pusher; and
a fastener, being magnetic conductive, the fastener including two hook portions disposed at two opposite ends of the fastener respectively, the fastener linearly slidably arranged within the guide rails, so as to protrude one of the hook portions from one of the first opening and the second opening,
wherein when the cover body is drawn close to the mainframe and the pusher is at the second position, one of the hook portions are attracted to enter the fastening groove by the fastening groove, so that the one of the hook portions are engaged with the fastening groove when the pusher is moved to the first position by the elastic element.

7. The two-way fastening structure for a tablet PC as claimed in claim 6, wherein the cover body has a sliding groove, and the pusher has a key body protruding from the sliding groove.

8. (canceled)

9. The two-way fastening structure for a tablet PC as claimed in claim 6, wherein the fastener is formed with a protruding portion embedded in the guide rail, such that the fastener moves along the guide rail.

10. The two-way fastening structure for a tablet PC as claimed in claim 6, wherein when the fastener is snapped into the fastening groove or released from the fastening groove, the pusher is located at the first position, and when the fastener enters into the fastening groove to be snapped or released, the pusher is located at the second position.
